(19) United States
(12) Patent Application Publication
(10) Pub. No.: US 2008/0000232 A1
(43) Pub. Date: Jan. 3, 2008

(54) SYSTEM FOR ADJUSTING ENERGY GENERATED BY A SPACE-BASED POWER SYSTEM

(76) Inventors: James E. Rogers, Hermosa Beach, CA (US); Gary T. Spirnak, Manhattan Beach, CA (US)

Correspondence Address: Vista IP Law Group LLP, 2040 MAIN STREET, 9TH FLOOR, IRVINE, CA, 92614, US

(21) Appl. No.: 11/677,420

(22) Filed: Feb. 21, 2007

Related U.S. Application Data
(63) Continuation-in-part of application No. 11/212,824, filed on Aug. 25, 2005.
Application No. 11/212,824 is a continuation of application No. 10/724,310, filed on Nov. 26, 2003, now Pat. No. 6,936,760.
(60) Provisional application No. 60/428,928, filed on Nov. 26, 2002.

(51) Int. Cl. F03G 6/06

(52) U.S. Cl. 60/641.15

(57) ABSTRACT

A space-based power system including a plurality of power system elements in space. The power system elements include solar cells that receive sunlight and generate electricity from sunlight, a power module for converting electricity into radio frequency or optical energy for transmission to a pre-determined location, such as a power station, planet or satellite. Emitters of the power module that output the energy are arranged in a nadir direction, and the solar cells are arranged in a non-nadir direction. One or more components are arranged to adjust the phase or timing of the energy output by the emitters.

### CROSS-REFERENCE TO RELATED APPLICATIONS

This application is a continuation-in-part of co-pending U.S. application Ser. No. 11/212,824, filed on Aug. 25, 2005, which is a continuation of U.S. application Ser. No. 10/724,310, filed Nov. 26, 2003, now U.S. Pat. No. 6,936,760, priority to which is claimed under 35 U.S.C. §120, and which claim priority under 35 U.S.C. §119 to U.S. Provisional Application No. 60/428,928, filed Nov. 26, 2002, the contents of all of which are incorporated herein by reference.

### FIELD OF THE INVENTION

Embodiments of the invention relate to space-based power systems and, more particularly, to adjusting the output of a space-based power system.

### BACKGROUND

Spaced-based power systems use the Sun's radiant power or solar flux to generate energy. The Sun's solar constant or flux is approximately 1.4 kW/m.sup.2 in earth orbit. For example, in geosynchronous orbit or GEO (22,400 miles or 36,000 km from Earth), a space solar power system is almost continuously immersed in sunlight.

Solar cells, solar conversion devices, and nuclear power devices on a space power system generate Direct Current (DC) electricity, which is converted to a transmission frequency, such as radio, microwave and laser frequencies. For example, with Radio Frequency (RF) and microwaves, the generated electricity is converted to power through conversion devices, e.g. magnetrons, and focused by an antenna. The focused energy is directed to a receiver, and a receive antenna (“rectenna”) converts the power beam into DC electricity. The DC electricity is converted into Alternating Current (AC) electricity, which is transmitted to a power grid for distribution to users.

As a result, some percentage of the solar constant is converted into usable electricity. For example, a 1 m.sup.2 solar array with a conversion efficiency of 40% can produce about 560 watts of electrical power. One million square meters or a one square kilometer 40% efficient solar array can generate about 560 megawatts (MW) of power.

Concepts to harness solar energy were initially developed in the 1960s. In the 1970s and 1980s, NASA and the Department of Energy conducted satellite system studies, but the low efficiency and high costs of these systems precluded their effectiveness. In the 1990s, NASA conducted further studies and developed new concepts in different orbits. The new systems made improvements relative to earlier studies, however, existing concepts were still not economically viable.

A typical space power system has a power generation subsystem for energy conversion and a wireless power transmission subsystem. Known systems that use photovoltaic cells typically utilize large solar arrays to convert solar energy into electricity. Connecting structures are typically used to maintain the correct relative positions of the system components.

Conventional space power systems can thus be improved. In particular, the connecting structures between power system components can be reduced or eliminated in order to reduce the weight of the system. In conventional systems, the connecting structures can comprise a majority of the weight of the systems. For example, some known systems utilize a transmit antenna in space having connecting structures that are many kilometers long and weigh millions of metric tons. The excessive weight of connecting structures can result in increased launch costs. Further, the excessive weight can strain system components, possibly impacting the alignment, operation and performance of the system. Thus, the weight of electrical and mechanical connections can be a limitation on the maximum size system that can be profitably implemented. Further, the positioning, orientation, and efficiency of power system components can be improved, particularly system components that are not linked together with connecting elements.

### SUMMARY

According to one embodiment, a space-based power system having a plurality of power system elements includes solar cells, a power module and one or more components that are configured to adjust the phase of energy output by emitters of the power module. The solar cells face a non-nadir direction, receive sunlight and generate electricity from the sunlight. The power module converts the electricity into energy for transmission to a pre-determined location. Emitters of the power module face a nadir direction and output the energy. One or more components are configured to adjust the phase of the energy output by the emitters.

According to another embodiment, a space-based power system includes solar cells, a power module and first and second mirrors. The solar cells face a non-nadir direction, receive sunlight and generate electricity from the sunlight. The power module converts electricity into energy for transmission to a pre-determined location. Emitters of the power module face a nadir direction and output the energy, which is received by the first mirror. The first mirror reflects the energy to a second mirror, which reflects phase-adjusted energy.

In accordance with yet a further embodiment, a space-based power system includes solar cells, a power module and a lens. The solar cells face a non-nadir direction, receive sunlight and generate electricity from the sunlight. The power module converts electricity into energy for transmission to a pre-determined location. Emitters of the power module face a nadir direction and output the energy. A lens adjusts the phase of the energy output by the emitters.

In another embodiment, a space-based power system includes solar cells, a power module and a phase retardation sheet. The solar cells face a non-nadir direction, receive sunlight and generate electricity from the sunlight. The power module converts electricity into energy for transmission to a pre-determined location. Emitters of the power module face a nadir direction and output the energy. The phase retardation sheet adjusts the phase of the energy output by the emitters.

In one or more embodiments, the energy generated by the power module can be radio frequency or optical energy, and the component that is used to adjust the phase of the energy is a radio frequency or optical component. The emitters and solar cells face different directions, e.g., opposite directions.

In one or more embodiments, a component that adjusts the phase of the energy generated by the power module includes first and second mirrors. The second mirror receives energy reflected by the first mirror. The first and second mirrors can be different shapes and sizes. For example, the mirrors can be convex and concave mirrors. The mirrors can be arranged so that the emitters output energy in a substantially nadir direction, the first mirror reflects energy in a non-nadir direction, and the second mirror reflects energy in a substantially nadir direction. One of the mirrors, as well as the solar cells can be attached to the power module.

In or more embodiments, a component that is used to adjust the phase of the energy includes a lens, such as a membrane lens.

In one or more embodiments, a component that is used to adjust the phase of the energy includes a phase retardation sheet, such as a Fresnel sheet, that includes phase adjustment elements that are opaque to the energy output by the emitters. For example, a phase retardation sheet can include circular non-opaque and opaque sections, and non-opaque and opaque sections arranged as concentric rings. A phase retardation sheet can also include tuned circuits that are arranged in similar arrangements.

In one or more embodiments, the space-based power system includes an intermediate power system element in space that reflects sunlight received from one power system element in space. Further, the space-based power system can include a distributed control system for maintaining alignment of one or more free-floating power system elements based on communications between control system components of adjacent power system elements.

### BRIEF DESCRIPTION OF THE DRAWINGS

Referring now to the drawings, in which like reference numbers represent corresponding parts throughout, and in which:

FIG. 1A illustrates an embodiment of a spaced-based power system with free-floating components;

FIGS. 1B-D illustrate views an embodiment of a system to control the positioning and alignment of power system components;

FIG. 1E illustrates an alternative embodiment having a phased array antenna;

FIGS. 2A-B illustrate plan and cross-sectional views of a collector or primary mirror;

FIG. 3 is a cross-sectional view of coatings on a mirror of the system;

FIGS. 4A-D illustrate different views of mirrors that are supported by an inflatable structure;

FIG. 5 is an illustration of an embodiment using inflatable mirrors and membrane elements;

FIG. 6 is an illustration of an embodiment using inflatable mirrors and membrane elements;

FIG. 7 is an illustration of an embodiment using inflatable mirrors and membrane elements;

FIG. 8 is an illustration of a further embodiment using inflatable mirrors and membrane elements;

FIG. 9 is an illustration of an embodiment of a generation subsystem having a photovoltaic power module and solar concentrators;

FIG. 10 is an illustration of an embodiment having a photovoltaic power module and multiple solar concentrators;

FIG. 11 is an illustration of an embodiment of a generation subsystem having a power cable to connect solar cells and photovoltaic module components;

FIG. 12 illustrates an embodiment of a wireless transmission system;

FIG. 13 illustrates another embodiment of a wireless transmission system;

FIG. 14 illustrates an embodiment of a space-based power system having a mirror and a power module that provides an output directly to a reflecting mirror;

FIG. 15 shows an embodiment of a space-based power system having a power module that is positioned between intermediate mirrors;

FIG. 16 illustrates an embodiment of a space-based power system having two intermediate mirrors in each of the generation and transmission subsystems;

FIG. 17 illustrates an embodiment of a space-based power system having three intermediate mirrors in each of the generation and transmission subsystems;

FIG. 18 illustrates an embodiment of a space-based system including radio frequency or optical components facing in nadir and non-nadir directions for focusing energy generated by a power module according to one embodiment;

FIG. 19 illustrates an embodiment of a space-based power system including radio frequency or optical components facing in nadir and non-nadir directions for focusing energy generated by a power module according to one embodiment;

FIG. 20 illustrates an embodiment of a space-based power system including a lens for focusing energy generated by a power module according to one embodiment;

FIG. 21 illustrates one embodiment of a lens shown in FIG. 20;

FIG. 22 illustrates an embodiment of a space-based power system including a phase retardation sheet; and

FIG. 23 is a plan view of an embodiment of a phase retardation sheet shown in FIG. 22 having opaque and non-opaque sections;

FIG. 24 is a plan view of an embodiment of a phase retardation sheet shown in FIG. 22 having tuned circuits;

FIG. 25 illustrates an embodiment of a space-based power system including multiple radio frequency or optical components for focusing energy generated by a power module according to another embodiment; and

FIG. 26 is a chart illustrating different energy diameters relative to different sizes of lenses.

### DETAILED DESCRIPTION OF ILLUSTRATED EMBODIMENTS

Embodiments of a space-based power system with one or more free-floating or free-flying system components that can be aligned will now be described. The embodiments include components that can be aligned while substantially reducing or eliminating connecting structures between system components, and using a control system to provide for alignment and positioning of free-floating system components.

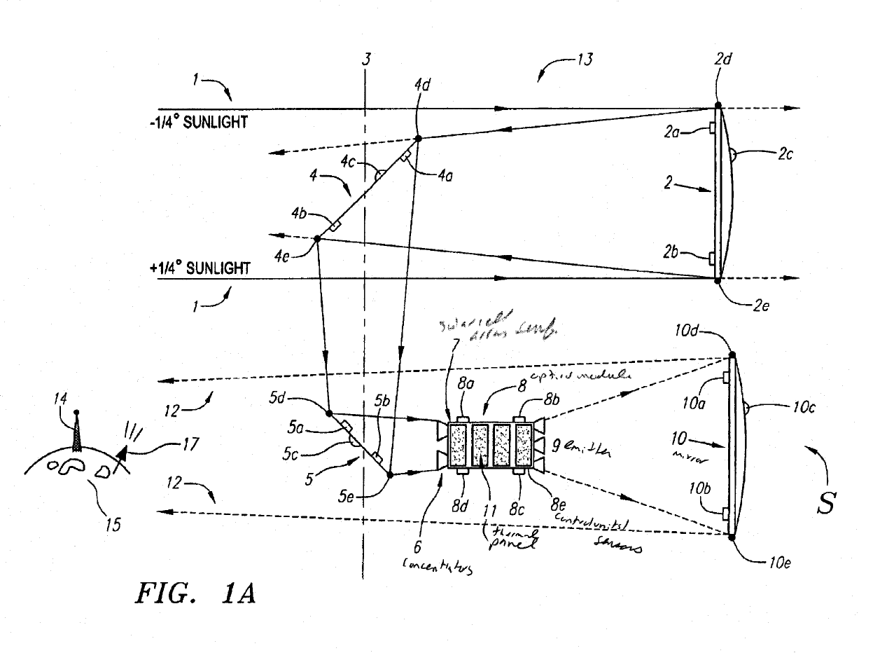

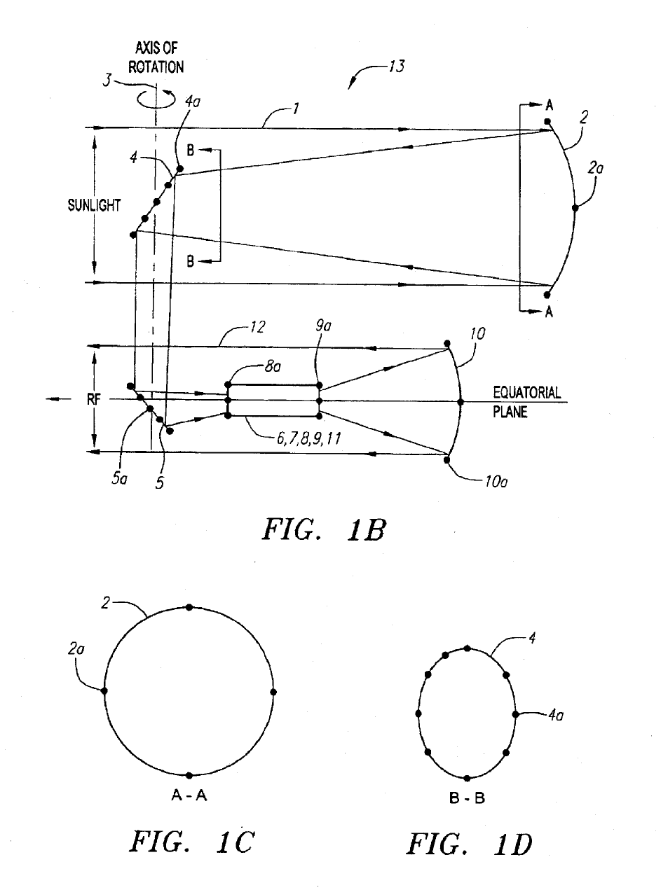

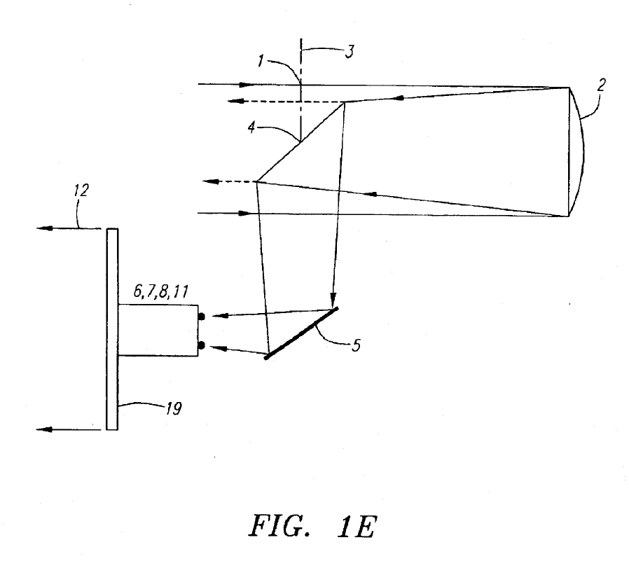

Referring to FIG. 1A, one embodiment of a space-based power system “S” includes power generation and transmission components. One embodiment of a system includes a primary or collection mirror 2, which orbits about axis 3, intermediate mirrors 4 and 5, a panel 11 with concentrators 6, an optical or power module 8 with solar cells 7, a transmitter feed or emitter 9, and a transmission subsystem that can include, for example, a reflector or output mirror 10 and one or more other mirrors as necessary. A control system 13 adjusts the shape, position, orientation and alignment of the power system components.

This specification generally refers to adjusting the alignment of system components for purposes of explanation, but the alignment can include a shape, a position, an orientation and other adjustments that can affect the alignment of system components. The system elements are arranged to collect sunlight, generate energy from the collected sunlight, and convert the energy into a form that can be transmitted to a receiver 14 at a pre-determined location 15, such as Earth or another location, where it is converted and distributed to users.

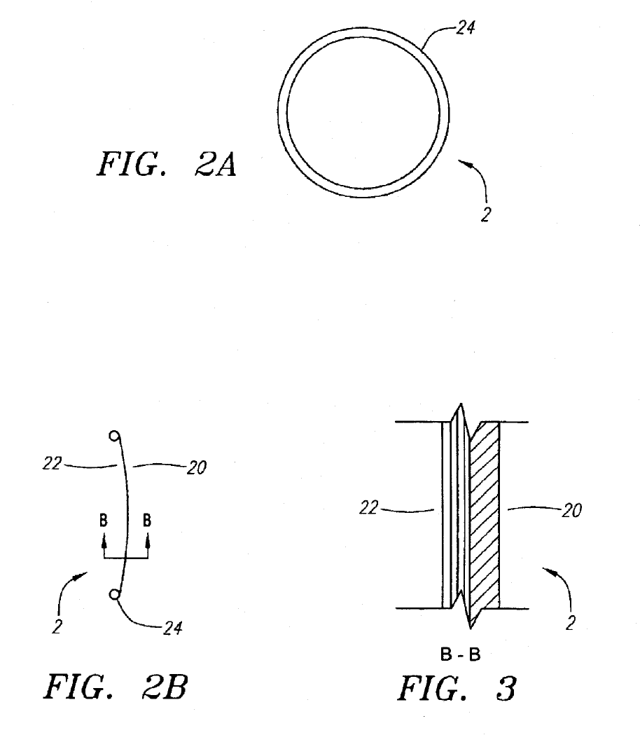

More specifically, the system components are positioned so that sunlight 1 is incident upon the primary mirror 2. The primary mirror 2 can be, for example, a nearly spherical mirror. The primary mirror 2 can be various sizes, e.g., having a diameter of about 1 km to about 2 km. The primary mirror (and other mirrors as described below) can be supported by a structure. For example, referring to FIGS. 2A-B, an inflatable tube or toroid 24 (generally 24) can surround the mirror 2. The tube 24 may be inflated using chemical or gas air tanks or other inflation systems.

Referring to FIGS. 2 and 3, one embodiment of a primary mirror 2 includes a substrate 20, such as a plastic substrate, that is coated with one or more films or optical coatings 22. The optical coatings reflect selected portions of sunlight 1 (e.g., particular wavelengths) that are most suitable for use by the solar cells 7. The selective reflection also reduces the photon force upon the mirror 2. Persons of ordinary skill in the art will recognize that various suitable substrate and coating combinations can be utilized for different mirror configurations and reflectivity and solar cell requirements.

Referring again to FIG. 1A, the sunlight 1 is reflected by the primary mirror 2 to a first intermediate mirror 4, such as a flat folding mirror. The mirror 4 tracks the orientation of the primary mirror 2 so that the two mirrors 2 and 4 remain in alignment. The first fold mirror 4 reflects the incident sunlight 1 onto a second intermediate mirror 5, such as a fold mirror. The second fold mirror 5 can be identical to the first fold mirror 4 or have another suitable design.

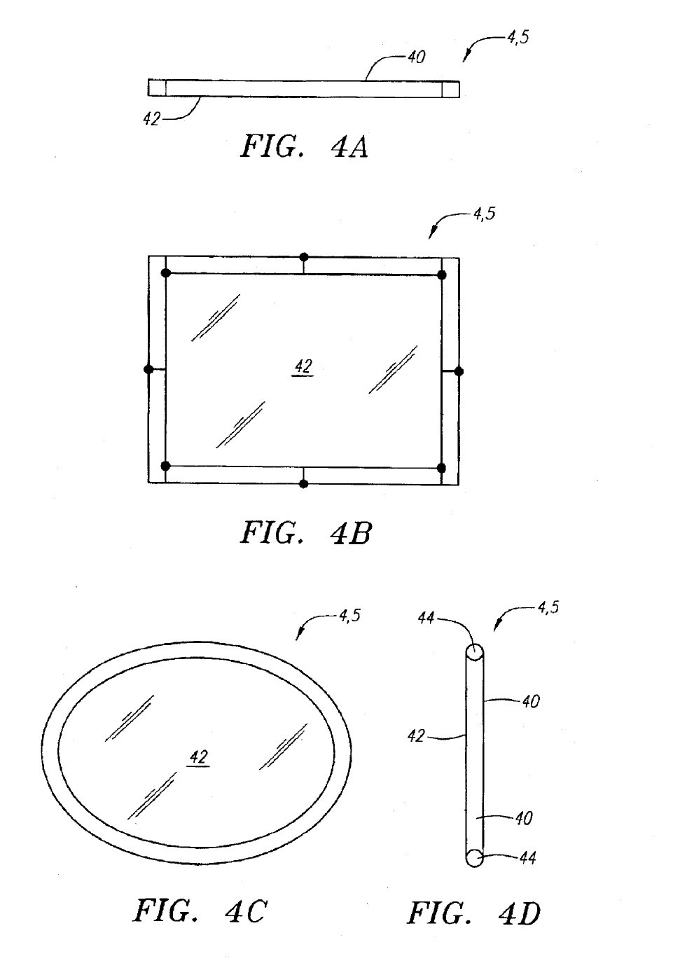

For example, referring to FIGS. 4A-D, a mirror in the space-based power system can be a flat mirror that includes a plastic substrate 40 and a coating 42, e.g., the same coating as the coating 22 on the primary mirror 2. For example, having the same coatings on the mirrors 2, 4, and 5 reduces the heat load on the solar cells 7. The coating 42 also reduces the solar photon pressure on the fold mirror. The mechanical residual stress in the coating can be set to the value needed to counteract the solar photon pressure, and maintain an optically flat surface. FIG. 4 also illustrates that the mirrors can also include inflatable supports 44.

Referring again to FIG. 1A, the mirror 4 rotates about the axis 3, and the mirror 5 tracks the concentrators 6. With proper maneuvering, the first fold mirror 4 reflects the incident sunlight 1 onto the second fold mirror 5. The second mirror 5 reflects light to one or more concentrators 6, such as non-imaging concentrators. The concentrators 6 magnify and smooth out spatial irregularities in the reflected beam of sunlight 1 received from the second fold mirror 5. The output of the concentrators 6 is directed to solar cells 7 of an RF or optical power module 8. Using concentrators allows an entire solar cell wafer to be utilized, resulting in more efficient energy production.

Various concentrator 6 focal lengths can be used to obtain the correct magnification of sunlight onto the solar cells 7 or other conversion devices. For example, the sun typically subtends an angle of approximately 0.5 degree at 1 a.u. (the distance from the sun to the earth). Thus, for example, the size of the focal spot could be 0.00873 times the focal length of the system.

Persons of ordinary skill in the art will recognize that various power modules can be utilized with different embodiments and systems. For example, as shown in the FIGS., the power module is a photovoltaic power module that utilizes solar cells. Alternative power modules include turbines, heat engines, and nuclear sources. A further alternative power module is a thermoelectric power module. A thermoelectric power module utilizes a temperature gradient, e.g., warmer front surfaces and cooler rear surfaces that result in a junction between two surfaces to generate electricity. For purposes of explanation and illustration, but not limitation, this specification refers to photovoltaic power modules with solar cells 7.

In one embodiment, the solar cells 7 are mounted near an input electrode of the modules 8. Thus, electrical cables from the solar cells 7 to the modules 8 are not needed. Eliminating these connectors reduces the mass of the system. Further, power losses in the system are reduced by reducing or eliminating power losses due to resistive (I.sup.2 R) heating in connecting cables. This arrangement also eliminates the need for other components typically associated with components connectors, such as insulation. Eliminating these components also reduces the weight of the power module, increases the performance of the cells, and reduces the cost of the cells.

The spacing arrangement of the solar cells 7 also allows heat to be conducted to the thermal panels 11, which radiate heat to space. Also, the concentrators 6 provide for dedicated solar cells 7 for each RF or optical power module 8. Thus, the concentrators provide for efficient use of incident sunlight 1. This arrangement is also advantageous since the solar cells are co-located with an energy conversion device, thus reducing the length of or eliminating connectors between these components. Co-location of these components is not practicable in typical known systems using connecting structures because of the need for the concentrator to track the Sun while the RF or optical section remains pointed at the Earth a user's substation.

The concentrators 6 with the fold mirror 5 shield the solar cells 7 from direct view of space and thus protect the solar cells 7. More specifically, the solar cells 7 are mounted on the power module, and the concentrators are mounted above the cells, thus shielding the solar cells 7 from a direct view of space except for a small solid angle centered on the incoming sunlight. The second fold mirror acts as a shield in this last direction so that the solar cells 7 are shielded in all directions, eliminating the need for solar cell cover slips (e.g., glass) and other protective coverings. As a result, the weight of the power system is further reduced by eliminating these components.

DC power generated by the solar cells 7 is converted by the RF or optical power modules 8 into a form that can be transmitted, such as RF or optical power. The RF or optical energy is radiated by the RF feeds or optical emitters 9 to the RF reflector, output mirror 10 (generally reflector 10), or directly to the predetermined location. For example, the RF feeds or optical emitters 9 can be arranged in a direct radiating array or a phased array antenna 19 (FIG. 1E), thus eliminating the need for a reflector 10. Waste heat from the solar cells 7, power modules 8, and RF feeds or optical emitters 9 is radiated into space by the thermal panels 11.

The reflector 10 is constructed so that the coating or incident surface reflects power to Earth or another predetermined location or station and transmits sunlight. By transmitting sunlight 1, the photon pressure on the reflector 10 is reduced or nearly eliminated. Since the reflector 10, may be as large as the primary mirror 2, reducing photon pressure results in a significant reduction in fuel that is needed for station-keeping of the reflector 10. However, as with the primary mirror 2, the residual photon pressure, in conjunction with the selected residual mechanical stress of the coating that reflects power and transmits sunlight 1, can be used to maintain the correct shape of the reflecting surface. This arrangement can reduce the weight of the reflector 10, for example, up to about 66% or more. Alternatively, an optical mirror 10 is constructed so that the coating reflects the desired optical wavelengths and transmits unwanted solar radiation.

The RF or optical energy 12 reflected by the reflector or mirror 10 can be a diffraction-limited beam that is generally focused and directed to a terrestrial antenna or collector 14 located on Earth or another desired location 15. A set of radio frequency or optical sensors at the antenna or collector measure the beam waveform shape and boresight. A feedback circuit 17 computes aspects of the received beam and send control signals back to the control system to adjust the alignment of one or more components, e.g., adjust the shape, position, or orientation of a component.

For example, if the emitters 9 and reflector 10 are not properly aligned, one or both of these components can be adjusted so that a beam 12 reflected from the reflector 10 is directed towards the receiving antenna 14. As a further example, the shape of the emitters 9 can be adjusted.

The proximity control system 13 or a separate control system is used to adjust the alignment of various power system components, for example, a primary or transmission mirror, an intermediate mirror, such as a fold-mirror, a reflector, a sub-reflector, and an antenna feed. The control system can also maintain the shape of the wave front of the transmitted electromagnetic wave. Other activities that can be performed by the control system include active mirror control, phase conjugation, and active antenna control.

In one embodiment, the control system 13 includes a sensor system and a displacement system to adjust the alignment of one or more system components in response to sensor data. Persons of ordinary skill in the art will recognize that a space-based power system can have different numbers of free-floating system elements. For example, one or more, most, or all of the elements can be free-floating in space. The control system can be configured to adjust the alignment of the free-floating elements, and elements that are not free-floating (e.g., tethered to other elements). This specification, however, refers to the control system aligning free-floating power system elements for purposes of explanation, but not limitation. For example, data from control system elements or sensors, such as radar and lidar sensors, can indicate the alignment of two or more components. The displacement system can include one or more thruster elements that can be activated or de-activated in response to the sensor data to adjust the alignment.

Referring to FIG. 1A, in one embodiment, the proximity control system is located in space and generally includes control units or sensors. 2a,b (generally 2a), 4a,b (generally 4a), 5a,b (generally 5a), 8a,b (generally 8a), 10a,b (generally 10a), and thrusters 2d,e (generally 2d), 4d,e (generally 4d), 5d,e (generally 5d), 8d,e (generally 8d), and 10d,e (generally 10d) on respective power system components 2, 4, 5, 8, and 10. The embodiment shown in FIG. 1A is merely illustrative of various proximity control configurations that utilize different numbers and positioning of proximity control system components.

For example, referring to FIGS. 1B-D, in another embodiment, the primary mirror 2 includes four sensors, and the intermediate mirrors 4 and 5 include eight sensors. FIGS. 1C and 1D illustrate cross-sectional views showing one possible sensor arrangement. In the illustrated embodiment, four proximity control system sensors 2a on the primary mirror 2 and a corresponding four sensors 4a on the mirror 4 are arranged to look at or communicate with each other. Similarly, four additional proximity control system sensors 4a on the mirror 4 and corresponding four sensors 5a on the mirror 5 are arranged to communicate with each other. Four additional units 5a on the mirror 5 and four units 8a on the module 8 are arranged to communicate with each other. Additionally, four units 9a on the emitters 9 and four units 10a on the reflector 10 are arranged to communicate with each other.

With this configuration, three sensor units can be utilized, with the fourth unit in a group serving as a back-up unit. The fourth unit can also be used to resolve anomalous behavior of other units. Further, if only one sensor unit is utilized, the other three units can be used to cross-check the first unit.

Thus, in the illustrated embodiments, the control system makes adjustments based on communications between sensors of adjacent elements, i.e., elements that communicate with each other by reflecting or receiving sunlight or other signals. For example, the primary mirror 2, fold mirrors 4 and 5, optical module 8 and reflector 10 can all include sensors. The sensors on the mirrors 2 and 4 communicate with each other, the sensors on the mirrors 4 and 5 communicate with each other, the sensors on the mirror 5 and the optical module 8 communicate with each other, and the sensors on the optical module 8 and the reflector 10 communicate with each other. The control circuit is configured to adjust a system component based on the alignment of the previously described pairs of components. Adjustments can be made based on alignments of other numbers and combinations of system components.

Thus, for example, in response to sensor data between mirrors 2 and 4, thrusters on the mirror 4 may be activated (or de-activated) to re-align the mirror 4 with respect to mirror 2. Similarly, thrusters on mirror 2 can be activated (or de-activated). After re-aligning one system component, one or more other system components can also be re-positioned to maintain proper alignment of the entire system. A monitoring system on Earth or another planet, body or station can also monitor and alter the alignment of system components.

In one embodiment, a proximity control system 13 uses complementary and redundant position-measuring devices, such as stereoscopic cameras, modulated laser diodes, and lasers. For example, lasers can form a closed loop of optically coherent beams, such that a change in relative positions and orientation of the system components produce a change in the interference pattern at each of the loop's detectors. Relative motion in a system can also produce Doppler shifts of the light beams that determine direction of motion. These changes and shifts can be used to maintain the relative positions of power system components, e.g., to sub-millimeter accuracies.

In another embodiment, multiple retro-reflectors and optical targets are placed on the circumference of the two concentrators and used for active and passive control. Laser transmitter/receivers and optical sensors are located on the power module, and the first fold mirror can monitor the position and orientation of these structures. The optical sensors can use stereoscopic images to measure precise orientation and approximate range.

Laser beams, such as modulated continuous wave (CW) laser beams, can be reflected from retro-reflectors. The phase of the returned beam can be compared to the phase of the transmitted beam. Pulsed laser beams can be reflected from the retro-reflectors and by measuring the time-of-flight, an independent range can be determined. Also a set of highly coherent CW laser beams can be reflected from retro-reflectors and interferometrically compared with the transmitted beams.

A change of one interference fringe can correspond to a change in range of one quarter wavelength of the laser emission line. Using homodyne detection, Doppler shifting of the beam can produce a beat frequency that is proportional to the rate of range change. Because of the extremely high frequency of the laser light, speeds of one millimeter per second can be measured. Thus, position and radial speed can be measured simultaneously with the proximity control system. Additionally, Charge Coupled Device (CCD) or stereoscopic cameras can be used to obtain spatial and angular measurements and range using stereoscopy of adjacent system components. These devices can also be used to navigate system elements into their initial (approximate) positions.

In an alternative embodiment, the proximity control system 13 uses a solar wind, primarily, and ion thrusters and electrostatic forces secondarily, to maintain the correct positions and orientations of the power system elements. The reflectors and fold mirrors can have paddle-like structures mounted on their circumference. The handle sections of the paddles point in the radial direction (with respect to the mirror) such that the paddles can be rotated with respect to the incident sunlight. By the proper rotation of the paddles, torques and forces can be imparted to the reflectors and fold mirrors. Ion engines can handle residuals that are not eliminated by the paddles. Furthermore, for free-floating elements that are not too distant, loose pseudo-tethers can provide limits and/or allow the use of repulsive-only forces to maintain positions if necessary. Thus, while embodiments of the invention eliminate or reduce connecting structures for aligning system components, they are also adaptable to other configurations, applications and supports. In another embodiment, the proximity control system 13 uses orbits, for example, about the Earth or other celestial body, so that the consumption of station-keeping fuel by the heaviest system elements is minimized. The other elements (e.g. fold mirrors of an optical or RF system) are positioned to maintain focus, alignment, boresight, etc. Since the latter elements are lighter, the station-keeping fuel required by the entire system is reduced. This configuration also provides greater flexibility in positioning reflectors with respect to the power module. Some components may be close enough that cables can tether them and repulsive electrostatic forces can be used to keep the cables taut.

Additionally, if necessary, the components can have distance or ranging sensors. For example, FIG. 1 illustrates distance sensors 2c, 4c, 5c, 8c, 10c that detect the distance between system components. Various types and numbers of distance sensors can be utilized as needed. If a component falls outside an acceptable range or an orbit, one or more thrusters can be activated to re-position the component within the accepted range.

For example, a modulated laser diode rangefinder can be used to provide a continuous range to adjacent system components by comparing the modulation phase of transmitted and received range signals. As a further example, a pulsed laser rangefinder can provide a continuous range to adjacent system components by measuring the time-of-flight of transmitted and received signals.

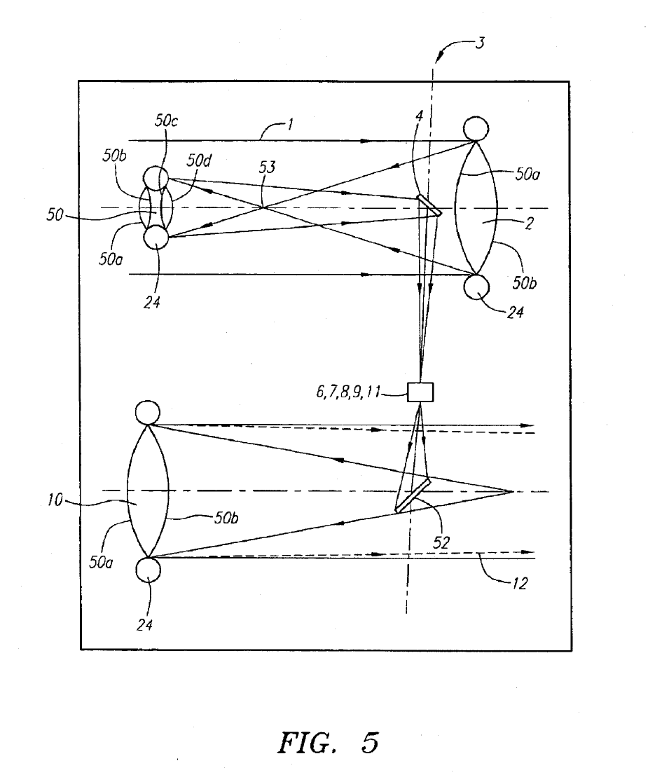

FIGS. 5-17 illustrate alternative embodiments of a power system having free-floating elements and how sunlight is captured and processed to produce electric power. The control system sensors and thrusters shown in FIG. 1 are not shown in FIGS. 5-17, however, the previously described components can also be used with the alternative embodiments. Further, the general manner in which the systems or components shown in FIGS. 5-17 is the same or similar to the system shown in FIG. 1. Thus, all of the details regarding generating RF or optical energy with the alternative embodiments are not repeated. Components of alternative embodiments that are the same as or similar to the components shown in FIG. 1 are represented with like reference numbers.

Referring to FIG. 5, in one embodiment, a space-based power system includes a lens system that includes parabola and hyperbola shaped lenses, such as a Cassagrain optical system, inflatable mirrors, and membrane support elements. More specifically, the system includes a primary mirror 2, a mirror 50, membranes 50a-d, such as transparent membranes, a first intermediate mirror 4, a module that includes concentrators 6, solar cells 7, an RF or optical module 8, RF transmitter feeds or optical emitters 9, and a thermal panel 11 (as in FIG. 1), a second intermediate mirror 52, and a reflector 10.

The mirror 50 may be an ellipsoid-shaped mirror and is supported by four membranes 550a-d. The mirrors 2 and 10 are supported by two membranes 50a-b. The membranes are used to maintain the proper shape of the mirrors 2, 10 and 50 using appropriate gas pressure. The mirrors are also supported by inflatable tubes or toroids (generally 24). The inflatable toroids can be folded up prior to launch and inflated by gas or chemical air tanks once in orbit.

Sunlight rays 1 are reflected by the mirror 2 to a focus point 53, from which they diverge and impinge on the mirror 50. The mirror 50 relays the image via converging rays to the folding mirror 4. The mirror 4 converges the rays to a magnified and even more blurred focus (e.g., now 0.34 km diameter), onto solar cell array surfaces 7 of the optical module 8.

For example, in one embodiment, solar concentrator 6 paraboloids can be approximately 2.25 km in diameter, of focal length 4.125 km, and f-number of 1.8. Similarly paraboloids used for transmitting microwaves can have a diameter of 2.25 km, a focal length of 5.975 km, and f-number of 2.6. In both of these selected cases, the focal spot size of the sun at the first focus 53 of the primary mirror solar collectors would be about 36 meters.

DC energy generated by the solar cells 7 is converted into RF or optical energy by the RF or optical power module 8. The larger blur size of the generated energy beam is intended to match the dimensions of the surface of the array and provide quasi-equal illumination.

The energy emanating from the module 8 is directed to the fold mirror 52. The fold mirror 52 is similar to a fold mirror 4 or 5 except that the mirror 5 is configured to reflect sunlight, whereas the mirror 52 is configured to reflect RF or optical energy. The fold mirror 52 directs the energy to the reflecting mirror 10, e.g., having a parabolic shape. The energy arrives at parabolic surface of the mirror 10 via expanding rays and reflects the output beam 12 to the pre-determined location, e.g., Earth or a space station. As shown in FIG. 5, the beam 12 reflected by the mirror 10 in this system is a substantially parallel beam or a diffraction-limited beam.

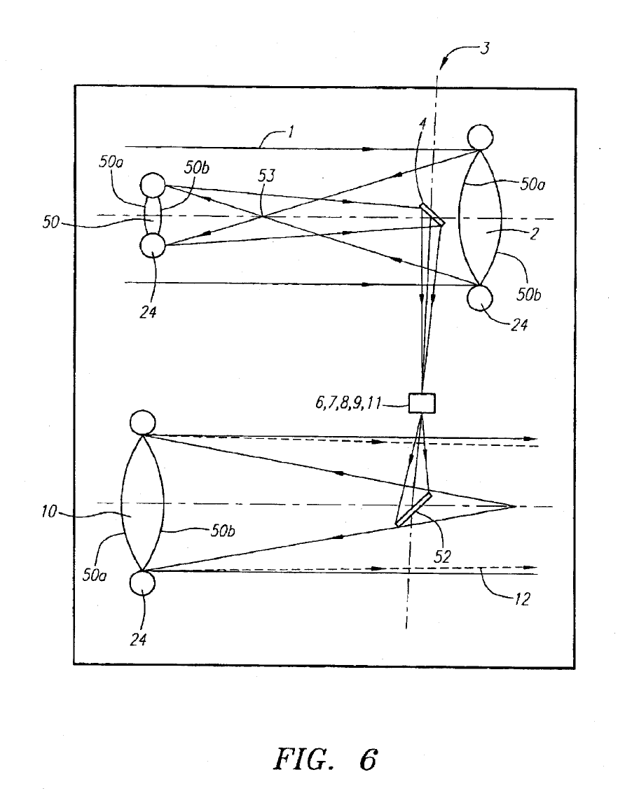

FIG. 6 illustrates a further alternative embodiment that utilizes an optical system that is similar to the system shown in FIG. 5. In this embodiment, the mirrors are supported by two membranes, whereas the mirror 50 is supported by four membranes as shown FIG. 1.

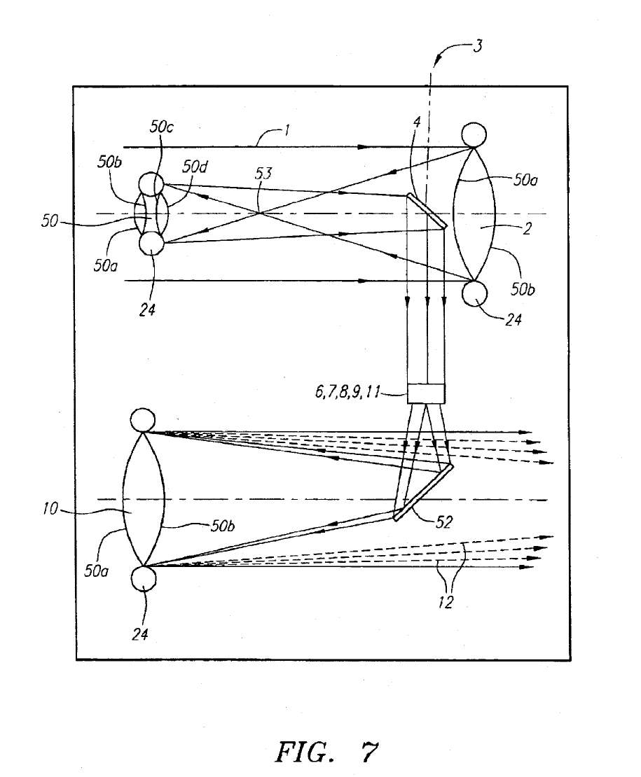

Referring to FIG. 7, an alternative embodiment of a space-based power system includes an optical system, such as a Coude optical system, inflatable mirrors, and four-membrane secondary elements. The components are configured so that rays of sunlight arrive and fall collimated onto the solar cell array surface 7 of the optical module 8. Further, the mirror 10 reflects the rays to a “spot” or a more focused point on the earth's surface compared to the systems shown in FIGS. 5 and 6.

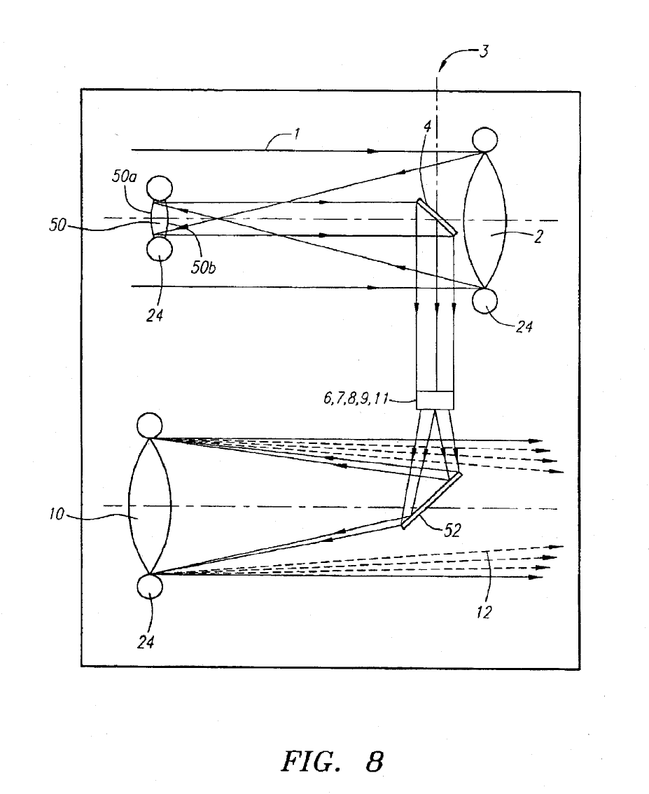

FIG. 8 illustrates a further alternative embodiment. This embodiment utilizes a configuration that is similar to that shown in FIG. 7, except that the system shown in FIG. 8 utilizes two membranes 50a,b to support each mirror.

The embodiments shown in FIGS. 5-8 operate in a similar manner as the embodiment shown in FIG. 1A except that other embodiments use, for example, different membrane systems and optical components.

The previously described space power gathering, converting and transmitting systems are compound cooperative, in that the gathering and transmitting elements and the conversion module have a common axis of rotation. This arrangement allows various “horizontal” angles to be utilized, between the sending and receiving elements of each system, to point one element at the sun and one towards the earth during various seasonal orbital situations. Further rotation of one element's optical axis plane about the optical axis of other elements allows precision pointing of the “vertical” axis of the transmitter to various locations on the earth, while holding the collector positioned on the sun.

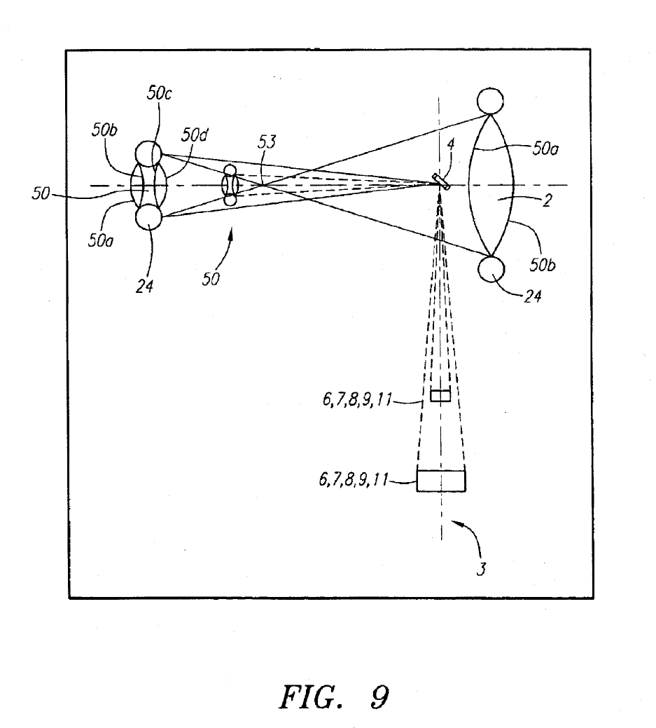

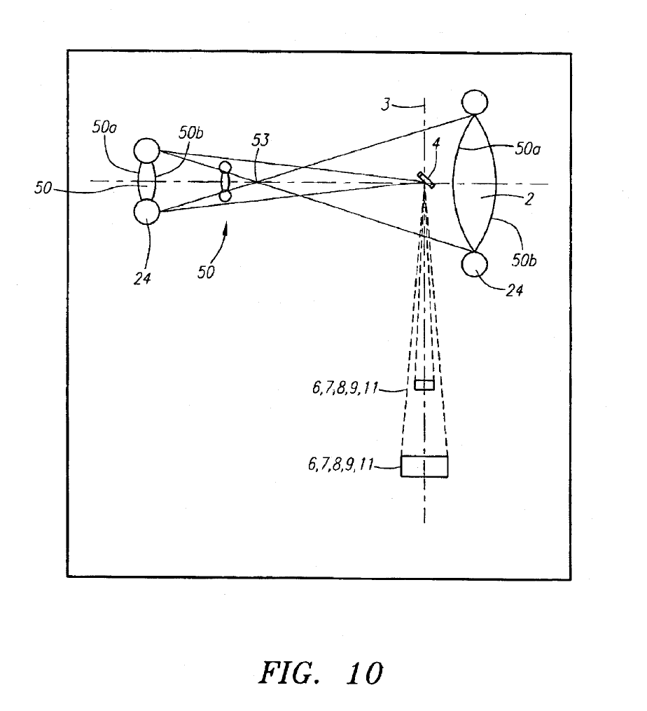

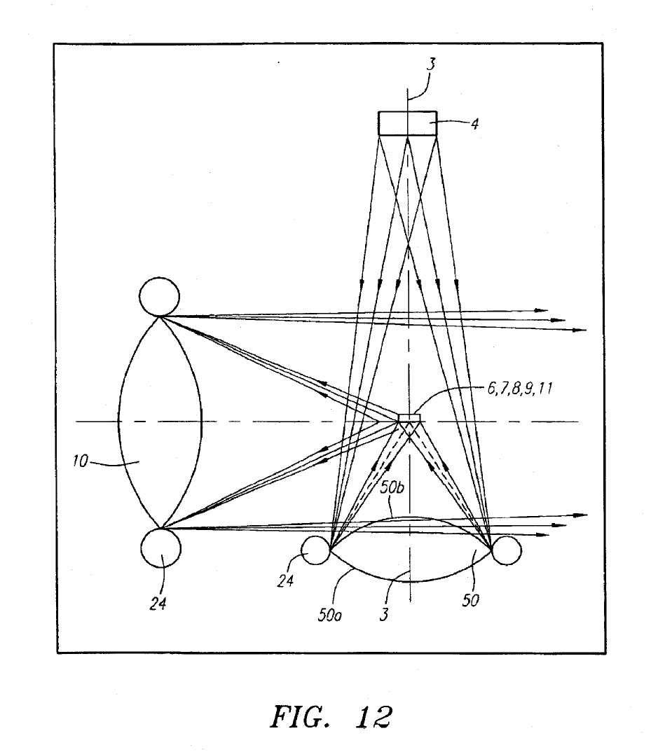

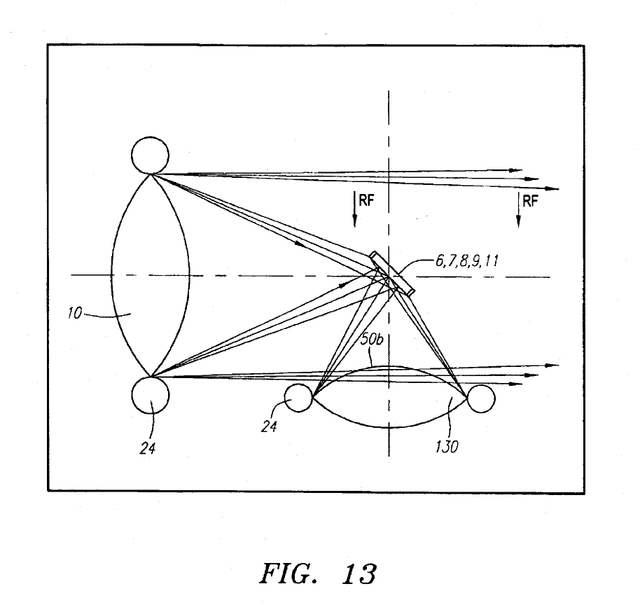

FIGS. 9-10 illustrate embodiments of a power generation subsystem. The wireless transmission subsystem components are not shown in FIGS. 9 and 10, however, various transmission subsystems can be utilized, including the previously described subsystems and the subsystems shown in FIGS. 12 and 13.

Embodiments of the generation subsystems of FIGS. 9 and 10 include inflatable mirrors, membranes, and multiple concentrators. In particular, the embodiments include a reflective mirror 2, a pair of mirrors 50, an intermediate mirror 4, and a pair of modules having a concentrator 6, solar cells 7, an RF or optical module 8, RF transmitter feeds or optical emitters 8, and a thermal panel 11 (as in FIG. 1). Four support membranes 50a-d support both of the mirrors 50 in the embodiment shown in FIG. 9, whereas two support membranes 50a,b support the mirrors 50 in the embodiment shown in FIG. 10. In both embodiments, the mirror 2 includes two support membranes 50a,b, one of the mirrors 50 is larger than the other mirror 50, and one of the modules (6,7,8,9,11) is larger than the second module. DC electricity generated by the solar cells and output by the emitters 8 is processed as previously described.

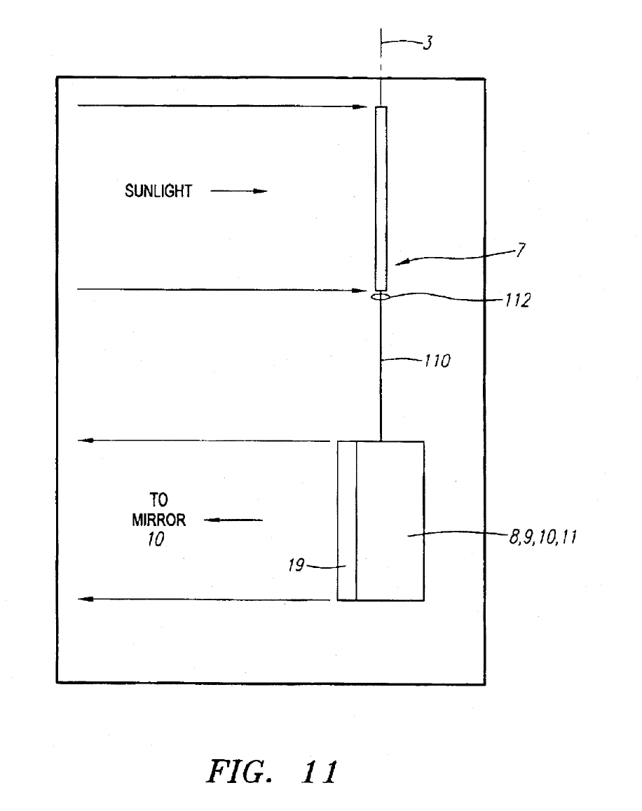

Referring to FIG. 11, in another embodiment, a power generation subsystem can be configured without concentrators. Thus, the module 8, emitter 9, reflector 10 and panel components can be integrated together and connected via a power cable 110 and an electrical slip ring 112 or other suitable coupling to the solar cells 7. When sunlight is incident upon the solar cells, the DC electricity generated by the solar cells is provided to the module (8,9,10,11) via the cable 110. The module converts the DC electricity into RF or optical energy, and the emitters 9 provide the RF or optical energy output to the phased-array antenna 19.

FIGS. 12 and 13 illustrate embodiments of wireless transmission subsystems that transmit RF or optical energy generated by a power generation subsystem. Various generation subsystems can be utilized, including the previously described generation subsystems.

Referring to FIG. 12, one embodiment of a transmission subsystem utilizes a mirror 4 and a concentrator system that is orthogonal to the direction of the output beam 12. Sunlight reflected from a mirror 4 is directed to an inflatable mirror 50 that is supported by two membranes 50a and 50b. The mirror 50 reflects the incident rays to a module having a concentrator 6, solar cells 7, module 8, emitters 9 and panel 11. The solar cells generate DC electricity, which is converted to RF or optical energy by the emitters 9. The output of the emitters 9 is directed to a reflector 10, such as an inflatable mirror, which is also supported by membranes and reflects the output beam 12.

The embodiment shown in FIG. 13 is configured for RF and utilizes a RF mirror element 130. More specifically, RF energy that is incident upon element 130 is reflected to a module having concentrators 6, solar cells 7, module 8, emitters 9 and panel 11. DC electricity generated by the solar cells 7 is converted by the module 8 into RF or optical energy. The emitters 9 output the RF or optical energy to the mirror 10, which reflects the output beam 12.

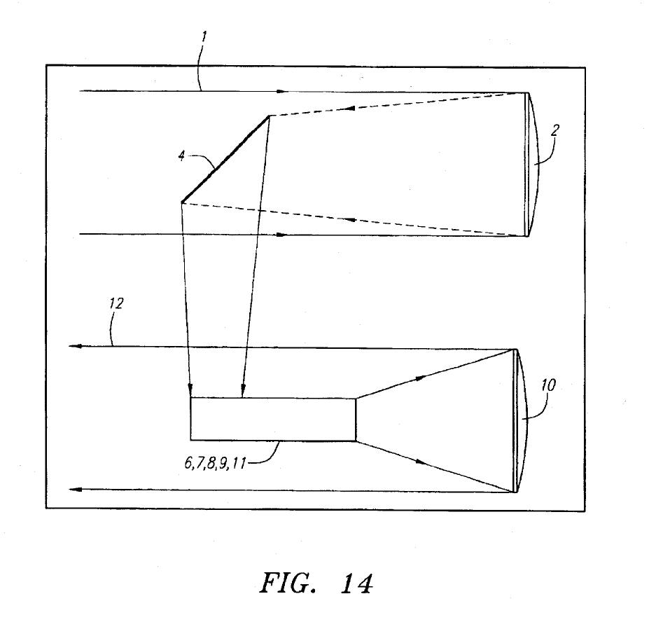

FIGS. 14-17 illustrate additional embodiments of space-based power system configurations. For example, FIG. 14 illustrates a configuration in which a single mirror 4 is configured to reflect sunlight 1 directly from the primary mirror 2 to the concentrators 6 and the solar cells 7, rather than reflecting sunlight indirectly to the concentrators utilizing a second intermediate mirror. The output of the emitters 9 is provided to the reflector 10, which reflects the output beam 12.

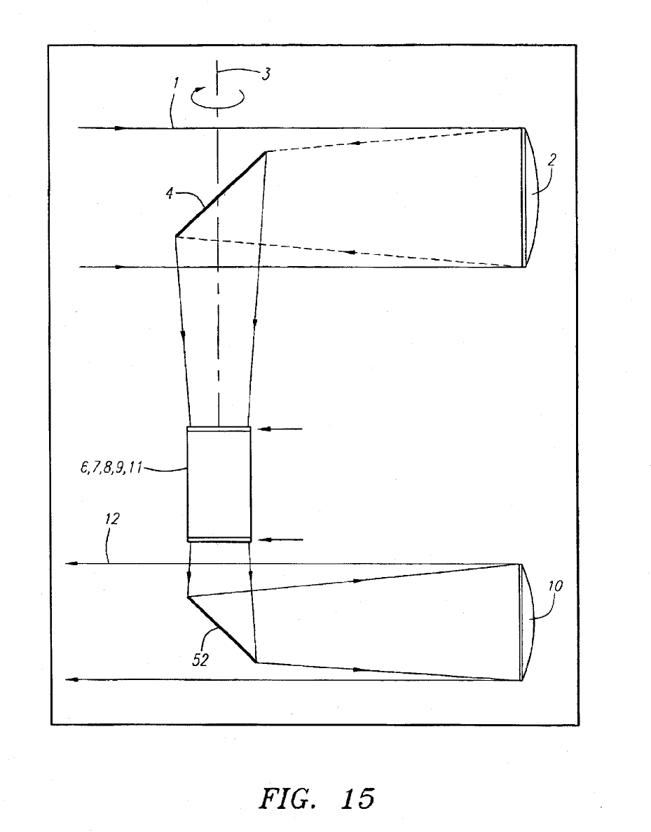

FIG. 15 illustrates a configuration that is similar to the configuration shown in FIG. 1, except that the module having components 6,7,8,9 and 11 is placed between the first and second mirrors 4 and 52. Thus, the RF or optical beam output by the emitters 9 is reflected by the second mirror 52, which reflects the beam to the reflector 10, which generates the output beam 12.

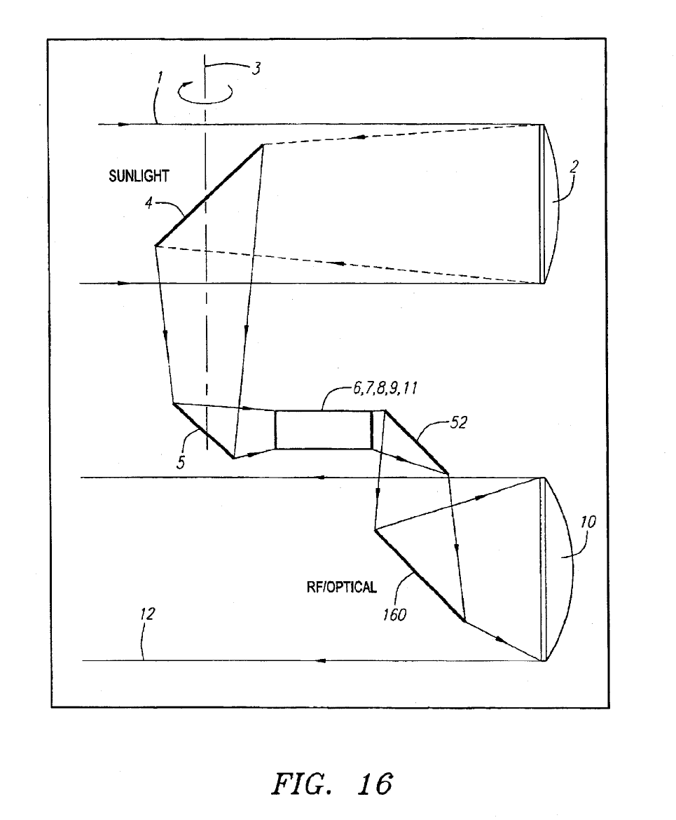

FIG. 16 illustrates a configuration in which the generation and wireless subsystems each include two intermediate mirrors, such as fold mirrors. More specifically, the generation subsystem includes a primary mirror 2, and intermediate mirrors 4 and 5, such as fold mirrors. The sunlight is reflected from the second mirror 5 to the module having the solar cells 7 that generated DC electricity. The emitters 9 convert the DC electricity into an RF or optical beam that is output to a mirror 52, which reflects the beam to a mirror 160. The mirror 160 reflects the beam to the mirror 10, which reflects the output beam 12.

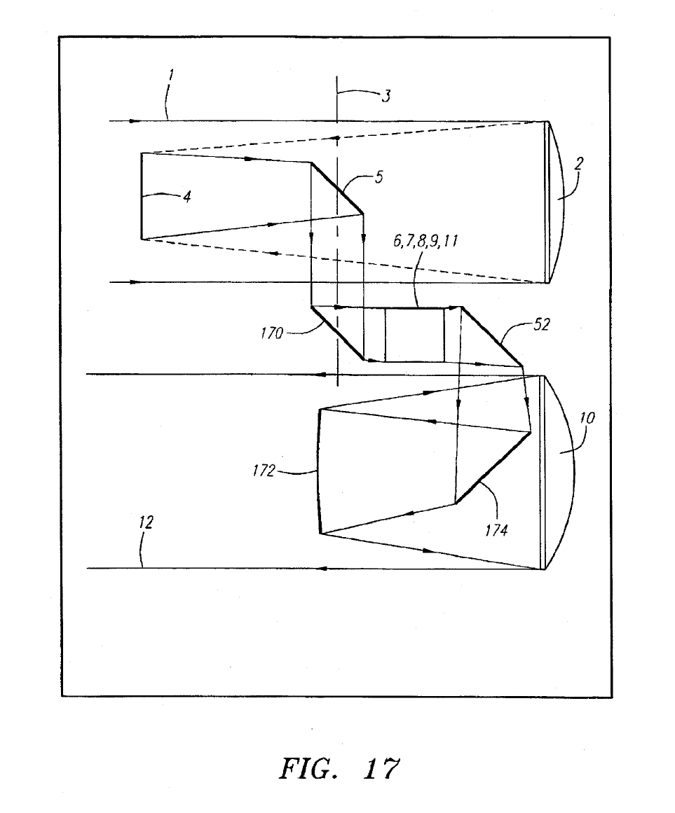

FIG. 17 illustrates an embodiment in which the generation and wireless subsystems each include three intermediate or fold mirrors. More specifically, the generation subsystem includes intermediate mirrors 4, 5, and 170, and the transmission subsystem includes intermediate mirrors 52, 172 and 174. Incident sunlight 1 is reflected from the mirror 2, to mirror 4, to mirror 5, to mirror 170 to the solar cells 7. The solar cells 7 generate DC electricity, and emitters 9 convert the DC electricity into a RF or optical beam that is output to a mirror 52, which reflects the beam to mirror 172, to mirror 174 and then to reflector mirror 10, which provides the output beam 12.

Persons of ordinary skill in the art will appreciate that the described and illustrated embodiments are advantages over known systems. For example, the connecting structures between system components are eliminated, thereby significantly reducing the weight of the system. Further, the free-floating system elements are aligned without using rigid connecting structural elements. Rather, these elements are free-flying and positioned and oriented using a proximity control system. Additionally, the spaced-based power system can be applied to various power station sizes, configurations and locations. For example, the space-based power system can be applied to a 1 GW power station situated in geostationary earth orbit (or any other orbit of need about any heavenly body of interest).

Further, since the elements of the illustrated embodiments are independent of each other (e.g. free-flying objects under the control of the proximity control system), the major structures (solar collector and the RF or optical transmission system) can be placed in orbits selected to minimize station-keeping fuel requirements of the system. The smaller fold-mirrors can be flown in other orbits, keeping the entire system in alignment and focus. Thus, the flexibility of the embodiments allows for reducing on-orbit fuel consumption.

Moreover, since the elements are free-flying, under the control of the proximity control system, failed elements can be moved out of position, and replacement elements can be moved into position. This flexibility simplifies the need for on-orbit module replacements and costly downtime. Failed system elements can also be placed in a parking orbit nearby so that, if in the future, repair or use for another mission is feasible, they will be readily available.

The space-based power system also enables the construction of large structures in space, specifically making the construction of a power station in geostationary earth orbit practicable, while overcoming shortcomings of prior systems that typically rely on heavy connecting structures. The elements of the system can also be precisely positioned, oriented and shaped without using large amounts of station-keeping fuel or structures.

The system provides an additional advantage of reducing photon pressure on the primary mirror 2 as a result of the selective reflection by the coating 2a. More specifically, the mechanical residual stress in the coating is set to counteract the solar photon pressure, and maintain an optically flat surface. The selective reflection may, reduce the solar photon pressure on the primary mirror by, for example almost 50%. To further reduce the heat load on the solar cells 7, the first fold mirror 4 can have the same coating as the primary mirror 2.

Further, by using large aperture optics, the need for a large solar array or a “farm” of many smaller collectors is no longer needed. Rather, a large reflector can collect and concentrate sunlight onto a much smaller solar array.

Persons of ordinary skill in the art will appreciate that various sizes, materials, shapes, and forms of optical elements can be used for other system configurations. Further, persons of ordinary skill in the art will appreciate that embodiments can use various frequencies including RF, infrared, and optical frequencies.

The system components can also be assembled in different manners. For example, the components can be flown to space separately, in its own orbit. The pointing direction of the components can then be adjusted for alignment with other system components.

Additionally, the embodiments can be utilized in different locations and environments. For example, power can be provided to various space and terrestrial locations including, but not limited to, the earth, the moon, other planets, space stations, space vehicles, and satellites. Similarly, the proximity control system can control the position of power system components from various locations, e.g., from the Earth, the moon, other planets, space stations, space vehicles and satellites. The embodiments can also be configured with different numbers of mirrors, membranes, concentrators and other components. Further, different numbers of power elements of a system can be free floating. For example, depending on a particular configuration or application, a few, most or all of the power system components can be free-floating or free of connectors.

Alternative embodiments for focusing RF or optical energy 12 generated by a power module 8 for transmission to a pre-determined location 15 or rectenna 14 are shown in FIGS. 18-26. Various aspects of space-based systems and methods discussed above are components of or can be used with embodiments shown in FIGS. 18-26. Thus, certain specific details discussed with reference to FIGS. 1A-17 are not repeated when describing embodiments shown in FIGS. 18-26.

Referring to FIG. 18, according to another embodiment, a space-based power system includes a plurality of power system elements in space that are arranged so that at least one component faces in a nadir direction 1801, and at least one other component faces in a non-nadir or anti-nadir direction 1802. A “nadir” direction 1801 is defined as a direction from a space-based power system to a predetermined location 15, such as the Earth, e.g., the center of mass of the Earth. A “non-nadir” direction 1802 is defined as a direction other than the nadir location 1801. A non-nadir direction 1802 may vary from the nadir direction 1801 by various degrees, e.g., by angles less than 90 degrees or by angles greater than 90 degrees.

According to one embodiment, a non-nadir direction 1802 is the opposite of a nadir direction 1801, i.e., 180 degrees relative to the nadir direction 1801. The angle between the nadir direction 1801 and the non-nadir direction may depend on, for example, the location of the sun, the location of the pre-determined location 15, the number of space-based system components, the position of one or more components, the orientation of one or more components, and/or the size of one or more components.

In the embodiment illustrated in FIG. 18, the space-based power system includes a mirror, such as an intermediate mirror 4 or 5 (generally, mirror 5). The mirror 5 reflects sunlight 1 from another mirror or power system element to one or more concentrators 6, the output of which is provided to one or more solar cells 7, which face the mirror 5 in a non-nadir direction 1802 and receive concentrated sunlight 1. The solar cells generate electricity from the sunlight, and the electricity is converted into RF or optical energy 12 by the power module 8. Emitters 9, which face the nadir direction 1801, output the energy 12 to one or more RF or optical components 1810 for adjusting the phase of and focusing the energy 12 for transmission from space to a rectenna 14 at a predetermined location 15. The RF or optical energy 12 is focused by the RF or optical component 1810 is shown as being collimated and having a diameter D. The energy 12 may have a diameter D at the output of the RF or optical component 1810 (as illustrated). Alternatively, the energy 12 may converge while being transmitted through space and to the pre-determined location 15 so that the diameter D is the diameter of the energy 12 at the pre-determined location 15. For purposes of illustration, this specification and related figures show the energy 12 having a diameter D following transmission through the RF or optical component 1810.

The space-based power system components can include components of a proximity control system, e.g., control units or sensors 5a,b; 8a,b; 1800a,b; displacement elements (e.g., thrusters) 5d,e; 8d,e; 1800d,e and distance sensors 5c, 8c, 1800c for purposes of maintaining alignment of power system elements based on communications between control system components of adjacent power system elements as discussed above with reference to FIG. 1A.

In the illustrated embodiment, the solar cells 7 and emitters 9 are co-located on the power module 8, the emitters 9 face the nadir direction 1801 (represented by ←), the solar cells 7 face a non-nadir direction 1802, and the RF or optical component 1810 is positioned between the emitters 9 and the pre-determined location 15. In the illustrated embodiment, the emitters 9 and solar cells 7 face opposite directions (180 degrees), but the angle between the nadir direction 1801 and the non-nadir direction 1802 can vary as discussed above. Further, in the illustrated embodiment, the energy 12 output by the nadir facing emitters 9 is in the nadir direction 1801 or substantially in the nadir direction 1801 and directed to a single RF or optical component 1810, which adjusts the phase of and focuses the energy 12 to a diameter D for transmission to the pre-determined location 15. In an alternative embodiment, the energy 12 can be provided to and/or reflected from multiple RF or optical components 1810.

For example, referring to FIG. 19, a space-based power system according to another embodiment includes multiple RF or optical components, e.g., first and second RF or optical components 1911 and 1912. In the illustrated embodiment, the emitters 9 face the nadir direction 1801, and the solar cells 7 face the mirror 5 in a non-nadir direction 1802. The first RF or optical component 1911 is positioned between the nadir facing emitters 9 and the pre-determined location 15, and the second RF or optical component 1912 is coupled to the power module 8.

According to one embodiment, the second RF or optical component 1912 can be coupled to the power module 8 so that energy 12 output by the emitters 9 in the nadir direction 1801 or substantially in the nadir direction 1801 is reflected by the first RF or optical component 1911 in a non-nadir direction 1802 to the second RF or optical component 1912. The second RF or optical component 1912 then reflects phased adjusted and focused RF or optical energy 12 having a diameter D back in the nadir direction 1801 towards the pre-determined location 15.

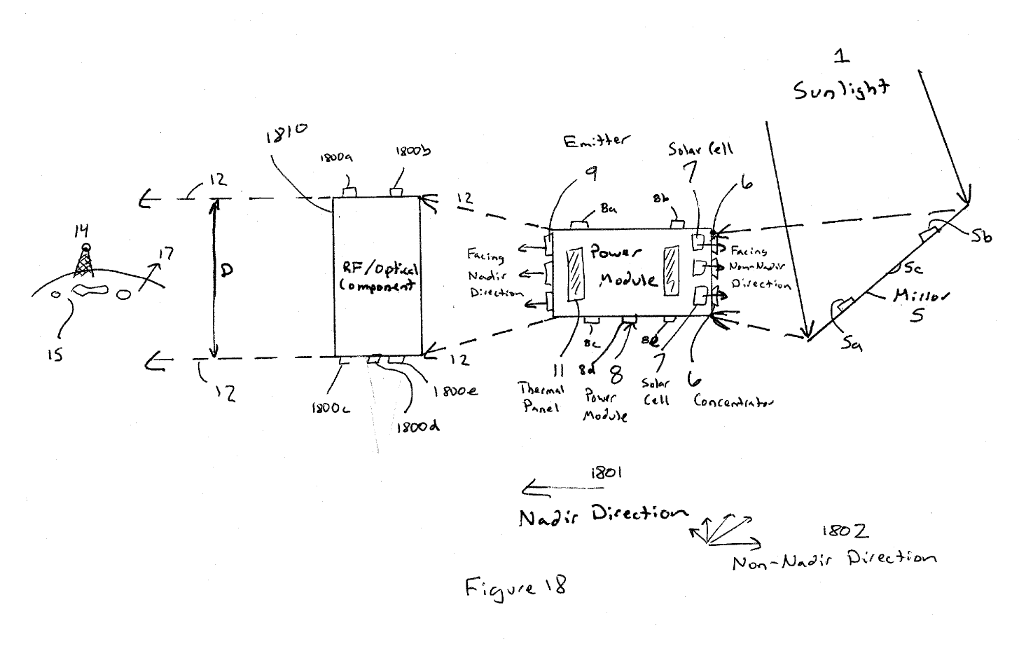

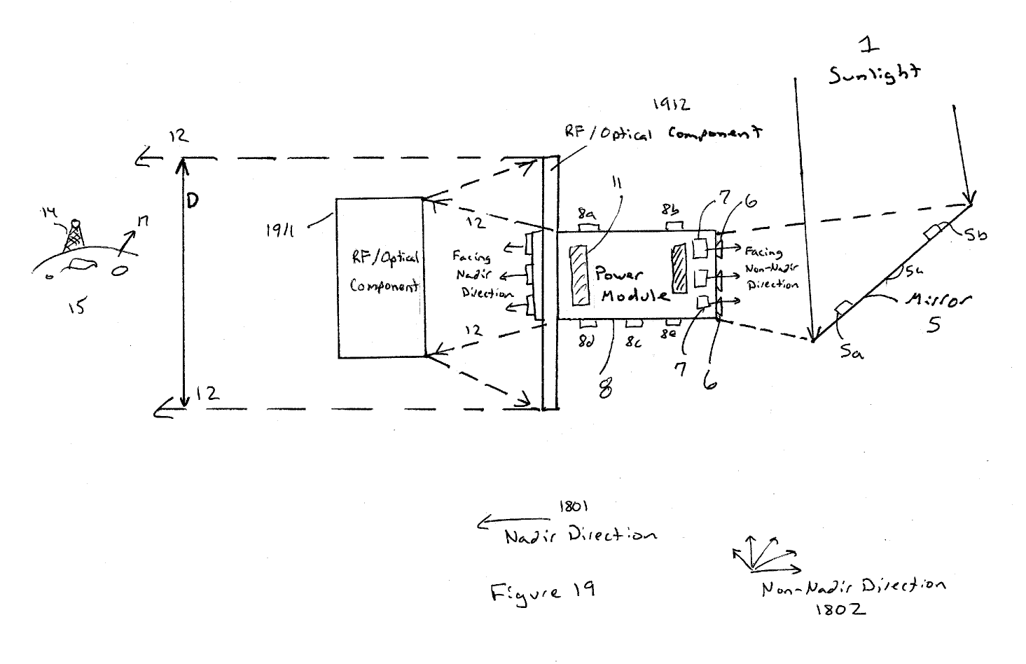

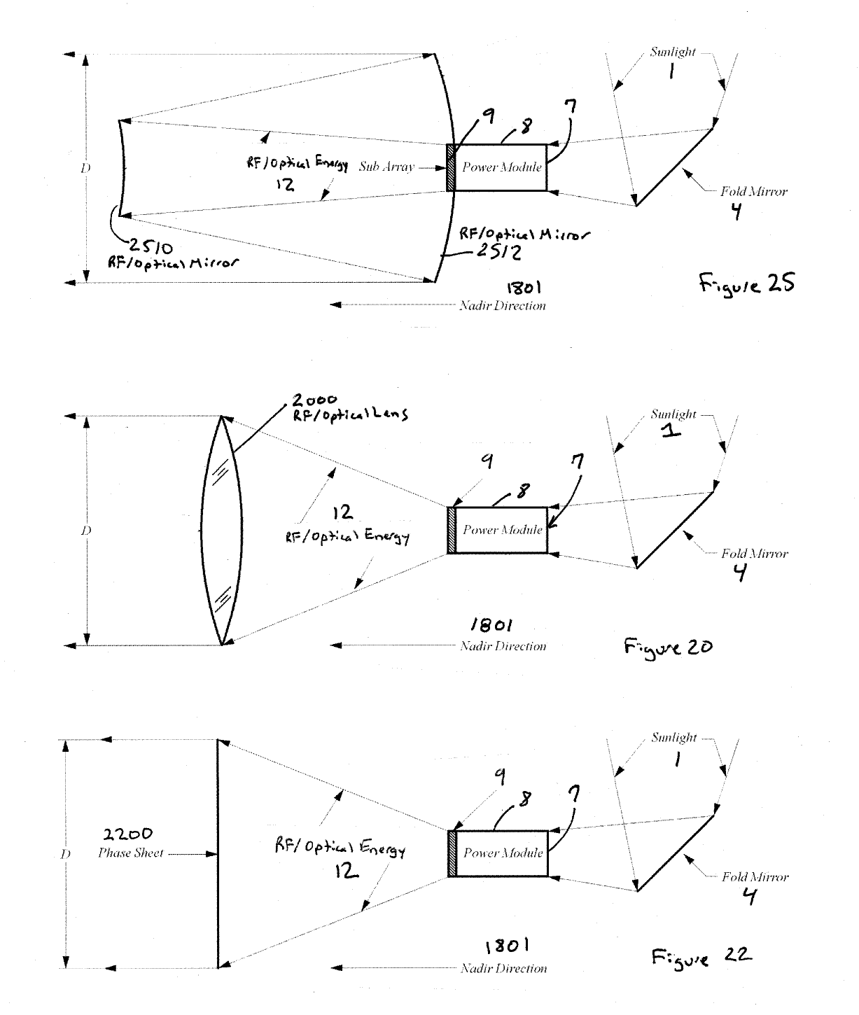

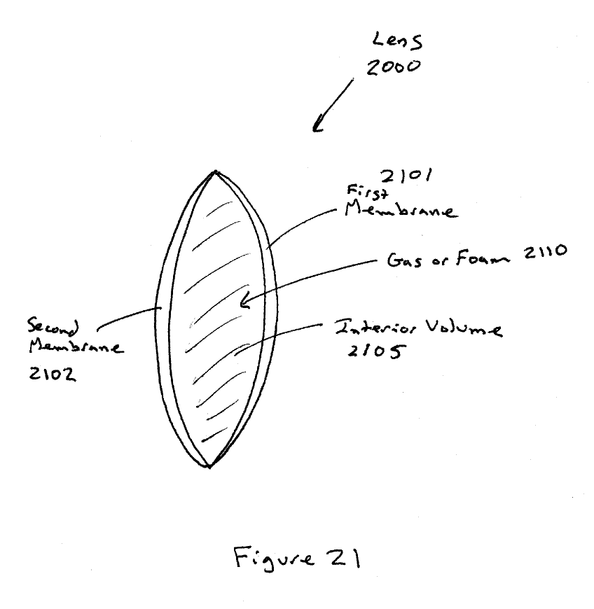

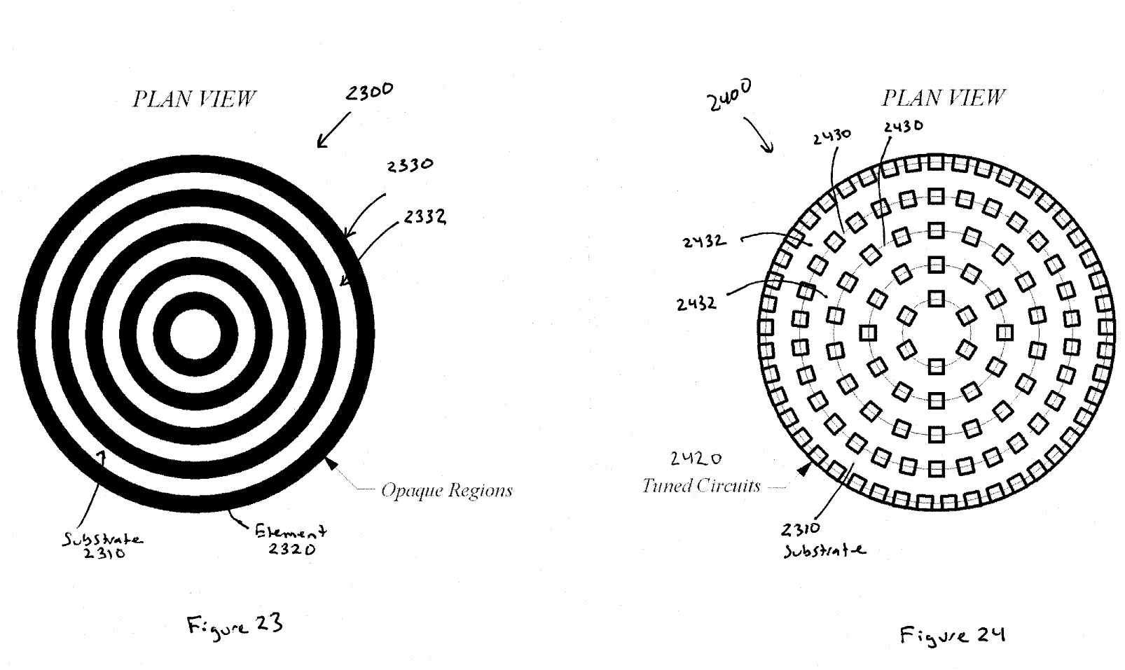

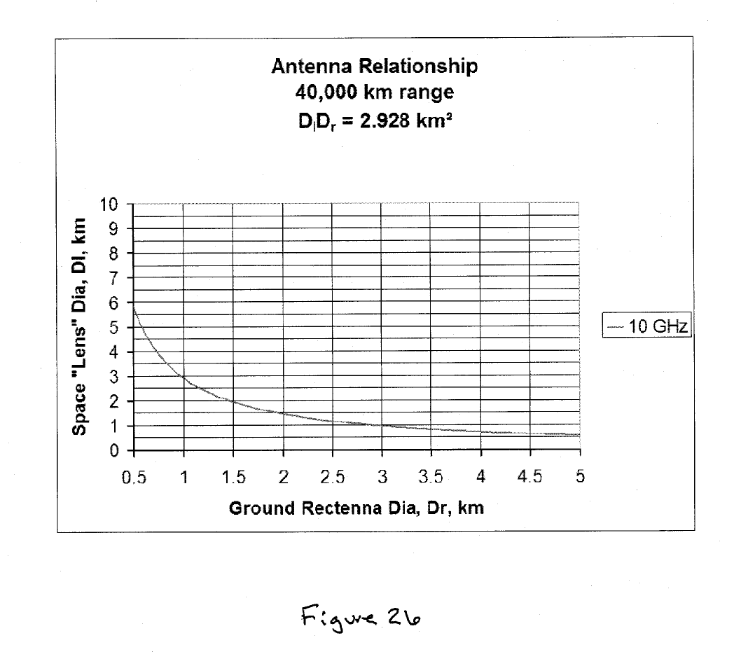

According to one embodiment, the second RF or optical component 1912 is attached to the power module 8 (as shown in FIG. 19), and the first RF or optical component 1911 is not attached to the power module 8. The second RF or optical component 1912 can be attached to various sections of the power module 8 depending on, for example, the configuration and design of the power module 8, the emitters 9 and/or the second RF or optical component 1912. Accordingly, FIG. 19 is provided for purposes of illustrating one example of a space-based power system having multiple RF or optical components and one way in which the second RF or optical component 1912 is attached to the RF or optical power module 8. FIGS. 20-24 illustrate in further detail examples of space-based power systems including one RF or optical component for focusing energy 12 from nadir facing emitters 9, and FIG. 25 illustrates in further detail an example of a space-based power system including multiple RF or optical components for focusing energy 12 from nadir facing emitters 9.

Referring to FIG. 20, according to one embodiment, the RF or optical component 1810 shown in FIG. 18 can be a lens 2000. Energy 12 from the nadir facing emitters 9 of the power module 8 is directed to the lens 2000, which adjusts the phase of the energy and focuses the in-phase energy 12 to a diameter D for transmission to the pre-determined location 15.

Referring to FIG. 21, according to one embodiment, one example of a suitable lens 2000 includes a first membrane 2101, a second membrane 2102, and a volume, space or cavity 2105 defined between the first and second membranes 2101 and 2102 (generally membrane 2101). One suitable membrane 2101 material is Kapton, which is available from E.I. du Pont de Nemours and Company, Wilmington, Del. In the illustrated embodiment, two separate membranes 2101 and 2102 are utilized, but persons skilled in the art will appreciate that different numbers of membrane 2101 sections can be utilized, and that the membrane 2101 can also be a single member. The first and second membranes 2101 and 2102 define the shape and size of the internal volume 2105. According to one embodiment, the internal volume 2105 is filled with a substance or material 2110, such as a nitrogen gas or a foam material. The type of substance or material 2110, the density of the substance or material 2110, the shape of the volume 2105 and/or the size of the volume 2105 is selected so that the substance or material 2110 has an index of refraction greater than one.

For example, suitable lenses 2100 can have a diameter of about 100 meters. Such lenses 2100 and the illustrated arrangements are capable of adjusting the phase of the energy 12 output by the emitters so that the energy 12 passing through the lens 2100 is in phase and can be collimated or focused to a desired diameter D, which can be about 0.5 to about 5.0 km depending on, e.g., the size and shape of the lens 2100.

Referring to FIG. 22, according to another embodiment, the optical component 1810 shown in FIG. 18 can be a sheet 2200, i.e., a phase retardation sheet, that adjusts the phase or timing of energy 12 passing through it. The phase retardation sheet 2200 alters or adjusts the phase of a portion of or all of the energy 12 to generate focused in-phase energy 12 for transmission to the pre-determined location 15.

Referring to FIG. 23, according to one embodiment, a phase retardation sheet 2300 includes a membrane or substrate 2310 and a plurality of elements 2320 attached to or deposited onto the substrate 231 0. According to one embodiment, the substrate 2310 is transparent to energy 12 from the emitters 9 so that energy 12 passes through the substrate 2310, whereas the elements 2320 on the substrate 2310 are opaque or substantially opaque and do not permit energy 12 to be transmitted or permit only very small amounts of energy 12 to be transmitted. The elements 2320 are suitable shapes and sizes to achieve the desired phase retardation and focus results.

For example, in the embodiment illustrated in FIG. 23, the opaque elements 2320 on the substrate 2310 are circular in shape, thereby defining circular opaque sections 2330 and transmissive substrate sections 2332. According to one embodiment, the transmissive circular sections 2332 and the opaque sections 2330 are configured so that they are arranged as concentric rings as shown in FIG. 23. According to one embodiment, the phase retardation or diffraction sheet 2300 is a Fresnel zone sheet. The concentric, RF-opaque rings 2330 have widths and diameters so that all or substantially all of the RF or optical energy 12 transmitted through the sheet 2300 is in phase after passing through the sheet 2300 and will come into focus at the pre-determined location 15.

For example, energy 12 along an inner circle or ring 2330 may have a different phase compared to energy 12 along an outer circle or ring 2330. As a result, energy 12 may arrive at the inner and outer circles or rings at different times, e.g., energy 12 may arrive at an outer ring 2330 after arriving at an inner ring 2330. With embodiments, the rings 2330 are arranged so that these phase or timing differences are compensated so that energy 12 passing through the sheet 2300 is in phase, and a collimated beam of in-phase energy 12 can be directed to a rectenna 14 at the pre-determined location 15.

In the illustrated embodiment, the phase retardation sheet 2330 includes alternating opaque rings or sections 2330 and transmissive substrate sections 2332. In the illustrated embodiment, the widths of the transmissive substrate sections 2332 and the widths of the opaque sections 2330 are approximately the same. The widths of one or more substrate sections 2332 and one or more opaque sections 2330 can be adjusted as necessary to adjust the phase retardation of the energy 12 in order to provide desired phase or timing adjustments.

Embodiments shown in FIGS. 22 and 23 may be suitable for, e.g., a phase retardation sheet 2300 having a diameter or width that can be about 1 meter to about several kilometers, e.g., about one to about four kilometers, and a thickness of about 0.1 micrometer to about 10 micrometers. The sheet 2300 can include about 20,000 opaque elements 2320 to define about 20,000 transmissive substrate sections 2332 and about 20,000 opaque sections. Thus, in one embodiment, about 50% of the substrate 2310 is covered by opaque elements 2320. The width of each section may be the same or different. For example, the width of each opaque section 2330 and each transmissive substrate 2332 can be about 1 cm. The thickness of the substrate 2310 can be about 1 micrometer, and the thickness of the elements 2320 can be about 1 micrometer. The phase retardation sheet 2300 can be a distance from the emitters 9 that is about two or more diameters of the retardation sheet 2300 and about 40,000 km from the predetermined location 15. Such phase retardation sheets 2300 and arrangements are capable of focusing the energy 12 so that the diameter of the energy beam received at the pre-determined location 15 is about 3/D, where “D” is the diameter of the phase-retardation sheet.

Referring to FIG. 24, according to another embodiment, the optical component 1810 shown in FIG. 18 can be a sheet 2400 having a plurality of circuits 2420 for adjusting the phase of a portion of or all of the energy 12 as the energy is transmitted through the sheet 2400. In the illustrated embodiment, the sheet 2400 includes a substrate, e.g., substrate 2310, and a plurality of circuit elements 2420, e.g., tuned circuits. The substrate 2310 is transparent to energy 12 from the emitters 9 so that the energy 12 passes through the substrate 2310, whereas the circuits 2420 on the substrate 2310 alter the phase of the energy 12. The circuits 2420 have suitable phase retardation characteristics so that phase or timing of the energy 12 emitted by the emitters 9 is adjusted after it passes through the sheet 2400 in order to provide desired phase or timing adjustments.

In the illustrated embodiment, the circuits 2420 are arranged in groups along concentric rings 2430 that define transparent sections 2432 there between. In the illustrated embodiment, the number of circuits 2420 in an inner ring 2430 is less than the number of circuits 2420 in an outer ring 2430, however, the number of circuits 2420 can vary as needed. As discussed above, the phase of energy 12 along an inner ring 2430 may differ from the phase or timing of energy along an outer ring 2430. Thus, for example, outer ring 2430 circuits can provide larger phase adjustments compared to inner ring 2430 circuits so that the energy 12 is in phase after passing through the sheet 2400.

Embodiments shown in FIGS. 22 and 24 may be suitable for, e.g., a phase retardation sheet 2400 having a diameter or width of about 1 meter to several kilometers. The thickness of the substrate 2320 can be about 5 micrometers. Examples of suitable circuits 2420 include RC circuits that provide desired phase adjustments. As an example, the sheet 2400 can include about 3×10⁹ circuits 2420 that are distributed among 20,000 rings 2430 of circuits. The number, arrangement, and phase adjustment capabilities of each circuit 2420 or groups or rings 2430 of circuits 2420 can be selected to provide the desired amount of phase retardation. The phase retardation sheet 2400 can be a distance from the emitters 9 that is about two or more times the diameter of the retardation sheet 2400, and about 40,000 km from the predetermined location 15. Such phase retardation sheets 2400 and arrangements are capable of focusing the RF or optical energy 12 so that the diameter of the energy beam received at the pre-determined location 15 is about 3/D, where “D” is the diameter of the phase retardation sheet 2400.

Referring to FIG. 25, according to another embodiment, the RF or optical components 1911 and 1912 shown in FIG. 19 can be mirrors. In the illustrated embodiment, energy 12 output by emitters 9 in a nadir or substantially nadir direction 1801 is directed to a first mirror 2510, which reflects energy to a second mirror 2512 in a non-nadir direction 1802. The second mirror 2512 reflects focused energy 12 back in the nadir or substantially nadir direction 1801 to the pre-determined location 15. The first and second mirrors 2510 and 2512 adjust the phase or timing of the energy 12 so that the energy reflected by the second mirror 2512 and to the pre-determined location is in phase and can be focused or collimated to a desired diameter D.

In the illustrated embodiment, the first and second mirrors 2510 and 2512 are different shapes and sizes, i.e., the first mirror 2510 is smaller than the second mirror 2512, and the first mirror 2510 is a convex mirror, and the second mirror 2512 is a concave mirror. Other mirror shapes and sizes can also be utilized as necessary.

For example, the first mirror 2510 can be a convex spherical mirror having a thickness of about 10 micrometers, a diameter that is about 20% of the diameter of the second mirror 2512, and a radius of curvature that is about 5-10%, e.g., about 6%, of the radius of curvature of the second mirror 2512. For example, the first mirror can have a diameter of about 200 meters, and a radius of curvature of about 250 meters.

The second mirror 2512 can be a concave spherical mirror having a thickness of about 2 micrometers, a diameter of about 1 kilometer, and a radius of curvature of about 4 kilometers. The first and second mirrors 2510 and 2512 can be separated from each other by about 3 kilometers. The first mirror 2510 can be about 40,000 kilometers from the pre-determined location 15. In the illustrated embodiment, the two mirrors 2510 and 2512 are separated from each other, but the second mirror 2512 is attached to the power module 8. For example, the second mirror 2512 can be attached to the module 8 in such a manner that it does not interfere with the emitters 9.

Persons skilled in the art will appreciate that different embodiments can be used for different applications and based on different space-based power systems and phase adjustment and focus needs. For example, embodiments shown in FIGS. 22-24 may be desirable if weight is a primary design factor, e.g., when larger diameter space-based system components are utilized. Further, embodiments shown in FIGS. 22-24 may be less sensitive to alignment errors between the RF emitters 9 and the phase-retardation sheet 2300 or 2400.

Further, persons skilled in the art will appreciate that different phase adjustments can be made based on, e.g., the type and size of the component, the number, type, size and arrangement of opaque rings (e.g., as shown in FIG. 23), and the number, type and arrangement of phase retardation circuits (e.g., as shown in FIG. 24). Further, the resulting beam of in-phase energy 12 transmitted to the pre-determined location 15 can have different diameters depending on, e.g., the type and size of the optical component that is utilized.

For example, FIG. 26 is a chart illustrating how the diameter of in-phase energy 12 at a ground rectenna 14 at a pre-determined location 15 varies with the size of a lens, e.g. a lens 2000 as shown in FIG. 20. As shown in FIG. 26, larger lens 2000 diameters are able to collimate the energy 12 to smaller diameters. For example, a lens 2000 having a diameter of about 4 km can be used to make the appropriate phase adjustments and collimate in-phase energy 12 so that the diameter of the energy when received by a rectenna 14 is about 0.75 km. As another example, a smaller lens 2000 having a diameter of about 1 km can be used to make the appropriate phase adjustments and collimate in-phase energy 12 so that the diameter of the energy 12 when received by a rectenna 14 is about 3 km in diameter. Persons skilled in the art will appreciate that similar component vs. energy diameter relationships exist when using other components or other numbers components, and that FIG. 26 illustrates one example involving lenses 2000 of different diameters.

Certain insubstantial modifications, alterations, and substitutions can be made to embodiments without departing from the scope of the accompanying claims. Thus, although particular embodiments have been shown and described, it should be understood that the above description is not intended to limit the scope of embodiments since various changes and modifications may be made without departing from the scope of the claims.

What is claimed is:

1. A space-based power system including a plurality of power system elements, the space-based power system comprising:
solar cells for generating electricity from sunlight, wherein the solar cells face a non-nadir direction;
a power module for converting the electricity into energy for transmission to a pre-determined location, wherein emitters of the power module output the energy and face a nadir direction; and
one or more components configured to adjust the phase of the energy output by the emitters.

2. The space-based power system of claim 1, wherein the energy is radio frequency or optical energy.

3. The space-based power system of claim 1, the one or more components including one or more radio frequency or optical components.

4. The space-based power system of claim 1, wherein the emitters and the solar cells face opposite directions.

5. The space-based power system of claim 1, the one or more components including:
a first mirror positioned to receive energy output by the emitters, and a second mirror positioned to receive energy reflected by the first mirror.

6. The space-based power system of claim 5, wherein the first mirror is a convex mirror, and the second mirror is a concave mirror.

7. The space-based power system of claim 5, wherein the first mirror is smaller than the second mirror.

8. The space-based power system of claim 5, wherein the emitters output energy in a substantially nadir direction, the first mirror reflects energy in a non-nadir direction, and the second mirror reflects energy in a substantially nadir direction.

9. The space-based power system of claim 5, wherein the second mirror is attached to the power module.

10. The space-based power system of claim 1, wherein the solar cells are attached to the power module.

11. The space-based power system of claim 1, wherein the one or more components includes a lens.

12. The space-based power system of claim 11, the lens comprising:
a first membrane,
a second membrane, and
a gas or a foam that occupies a space between the first and second membranes.

13. The space-based power system of claim 1, wherein the one or more components includes a phase retardation sheet.

14. The space-based power system of claim 13, the phase retardation sheet comprising:
a substrate that is transparent to energy output by the emitters; and
a plurality of phase adjustment elements mounted on the substrate, the phase adjustment elements being opaque to the energy and being configured to adjust the phase of the energy.

15. The space-based power system of claim 13, the phase retardation sheet including non-opaque and opaque sections.

16. The space-based power system of claim 15, the non-opaque and opaque sections being circular.

17. The space-based power system of claim 15, the non-opaque sections and the opaque sections being arranged as concentric rings.

18. The space-based power system of claim 13, the phase retardation sheet comprising a Fresnel zone sheet.

19. The space-based power system of claim 13, the phase retardation sheet comprising a plurality of tuned circuits.

20. The space-based power system of claim 19, the plurality of tuned circuits being arranged in groups of concentric rings.

21. The space-based power system of claim 1, the plurality of power system elements further comprising
at least one intermediate power system element in space that reflects sunlight received from one power system element in space, the at least one intermediate power system element transmitting the sunlight to another power system element in space for transmission to the solar cells.

22. The space-based power system of claim 1, further comprising
a distributed control system, the plurality of power system elements including a control system component of the distributed control system, wherein the distributed control system maintains alignment of one or more free-floating power system elements based on communications between control system components of adjacent power system elements.

23. The space-based power system of claim 22, wherein the control system adjusts a position, an orientation, or a shape of a power system element.

24. The space-based power system of claim 22, wherein the control system includes a displacement element that is selectively activated to adjust an alignment of a power system element in space.

25. The space-based power system of claim 24, each element in space having a displacement element.

26. The space-based power system of claim 22, wherein the control system includes a plurality of sensors, and data from sensors of two power system elements in space is compared to determine whether the two power system elements are properly aligned.

27. The space-based power system of claim 26, wherein sensors of adjacent power system elements are arranged to communicate with each other.

28. The space-based power system of claim 22, wherein the control system maintains optical alignment of a plurality of free-floating power system elements in space.

29. The space-based power system of claim 1, wherein the power system elements are maintained in an orbit.

30. The space-based power system of claim 1, the plurality of power system elements including:
a primary mirror; and
an intermediate mirror, wherein the primary mirror reflects sunlight to the intermediate mirror, and the intermediate mirror reflects sunlight to the solar cells.

31. The space-based power system of claim 30, further comprising
a second intermediate mirror, wherein
the primary mirror reflects sunlight to the first intermediate mirror,
the first intermediate mirror reflects the sunlight to the second intermediate mirror, and
the second intermediate mirror reflects sunlight to the solar cells.

32. The space-based power system of claim 1 being configured to transmit the phase-adjusted energy to a planet, a space station or a satellite.

33. The space-based power system of claim 1, wherein a majority of the power system elements of the plurality of power system elements are free-floating in space.

34. The system of claim 1, wherein all of the power system elements are free-floating in space.

35. A space-based power system including a plurality of power system elements in space, the space-based power system comprising:
solar cells for generating electricity from sunlight, wherein the solar cells face a non-nadir direction;
a power module for converting the electricity into energy for transmission to a pre-determined location, wherein emitters of the power module output the energy and face a nadir direction;
a first mirror positioned to receive energy output by the emitters; and
a second mirror positioned to receive energy reflected by the first mirror and to reflect phase-adjusted energy.

36. The space-based power system of claim 35, wherein the first mirror is a convex mirror, and the second mirror is a concave mirror.

37. The space-based power system of claim 35, wherein the emitters output energy in a substantially nadir direction, the first mirror reflects energy in a non-nadir direction, and the second mirror reflects energy in a substantially nadir direction.

38. The space-based power system of claim 35, wherein the second mirror, the emitters and the solar cells are attached to the power module.

39. A space-based power system including a plurality of power system elements in space, the space-based power system comprising:
solar cells for generating electricity from sunlight, wherein the solar cells face a non-nadir direction;
a power module for converting electricity into energy for transmission to a pre-determined location, wherein emitters of the power module output the energy and face a nadir direction; and
a lens for adjusting the phase of the energy output by the emitters.

40. A space-based power system including a plurality of power system elements in space, the space-based power system comprising:
solar cells for generating electricity from sunlight, wherein the solar cells face a non-nadir direction;
a power module for converting electricity into energy for transmission to a pre-determined location, wherein emitters of the power module output the energy and face a nadir direction; and
a phase retardation sheet for adjusting the phase of the energy output by the emitters.

41. The space-based power system of claim 40, the phase retardation sheet including
a substrate that is transparent to energy output by the emitters, and
a plurality of elements on the substrate, the plurality of elements being opaque to the energy and being configured to adjust the phase of the energy.

42. The space-based power system of claim 41, the phase retardation sheet including non-opaque sections and opaque sections.

43. The space-based power system of claim 41, the non-opaque and opaque sections being circular.

44. The space-based power system of claim 43, the non-opaque sections and the opaque sections being concentric rings.

45. The space-based power system of claim 43, the phase retardation sheet comprising a Fresnel zone sheet.

46. The space-based power system of claim 41, the phase retardation sheet including
a substrate that is transparent to energy output by the emitters, and
a plurality of tuned circuits mounted on the substrate, wherein the plurality of tuned circuits are configured to adjust the phase of the energy.

47. The space-based power system of claim 46, the tuned circuits being arranged in groups of concentric rings.
